(19) United States
(12) Patent Application Publication
(10) Pub. No.: US 2026/0116779 A1
(43) Pub. Date: Apr. 30, 2026

(54) Fluorinated Lithium- and Manganese-rich Layered Oxides and Methods of Making Thereof

(71) Applicant: The Regents of the University of California, Oakland, CA (US)

(72) Inventors: Guoying Chen, Oakland, CA (US); Faxing Wang, Nanjing (CN)

(21) Appl. No.: 19/052,661

(22) Filed: Feb. 13, 2025

Related U.S. Application Data
(60) Provisional application No. 63/557,085, filed on Feb. 23, 2024.

(51) Int. Cl. C01G 53/50; C01G 53/82; H01M 4/505

(52) U.S. Cl. CPC C01G 53/50; C01G 53/82; H01M 4/505; C01P 2002/54; C01P 2002/72; C01P 2002/77; C01P 2002/85; C01P 2004/03; C01P 2004/04; C01P 2006/40

(57) ABSTRACT

This disclosure provides systems, methods, and apparatus related to fluorinated lithium- and manganese-rich layered oxides. In one aspect, a method includes mixing metal precursors to form a first mixture. The metal precursors include a lithium precursor and a manganese precursor. A halide mixture is mixed with the first mixture to form a second mixture. The halide mixture includes a fluorine precursor and a chlorine reaction medium. The second mixture is heat treated to generate a fluorinated Li- and Mn-rich oxide.

### RELATED APPLICATIONS

This application claims priority to U.S. Provisional Patent Application No. 63/557,085, filed Feb. 23, 2024, which is hereby incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

Lithium- and manganese-rich (LMR) layered oxides, discovered more than two decades ago, have the potential to replace the LiNi_{1-x-y}MnₓCo_{y}O₂ (NMC)-type cathodes currently used in commercial lithium-ion batteries (LIBs). These materials offer a higher specific capacity (˜250 mAh·g⁻¹), higher energy density (>800 Wh·g⁻¹), better thermal stability, and lower cost. Several challenges, however, have hindered their commercial adoption, particularly impedance rise at low state of charge, capacity, and voltage fade with cycling. While the combined cationic and anionic redox activities contribute to the large capacity of LMR cathodes, cycling is often accompanied by irreversible loss of oxygen from the lattice. The removal of both Li and lattice oxygen upon charging to high voltages (e.g., 4.8 V) results in the migration of the transition metals (TMs) from the undercoordinated to fully coordinated octahedral sites in the Li layer. Such irreversible TM migration and Li/O loss lead to structural changes from the layered to a LiMn₂O₄-type spinel phase and, consequently, voltage decay, capacity fade, poor initial Coulombic efficiency (ICE), and sluggish reaction kinetics.

To address these performance issues, cation doping (e.g., Na, Mg, Cr, etc.), anion doping (e.g., PO₄, SO₄, etc.), surface coating (e.g., Al₂O₃, spinel phase, etc.), compositional engineering, and morphological modifications have all been explored in the past. Since O loss often occurs on particle surfaces, surface coating and/or doping of the O sublattice have shown promise. Among them, fluorination is widely explored. Due to the lower highest occupied molecular orbital (HOMO) level of F⁻ anions than that of the O²⁻ anions, F doping enables stronger metal-fluorine (M-F) bonds as compared to the M-O bands. F doping can also protect the electrode surface against HF attack, a common issue associated with the LiPF₆-based electrolytes. Further, the lower negative charge in F reduces the average cation oxidation state in the oxide, leading to increased capacity contribution from the TM redox couples.

In theory, F doping in the classic NMC-type phases is considered unfavorable due to the low solubility of LiF in a well-ordered layered crystal structure. First-principles calculations showed that the ability to incorporate fluorine into lithium-excess transition-metal oxides is closely related to their cation disordering degree. Disorder in the cation sublattice can create local Li-rich environments, increasing LiF solubility. Experimentally, several groups reported that fluorine is present as a LiF coating on the surface instead of a dopant in the layered LMR lattice. This was largely supported by ¹⁹F magic-angle spinning nuclear magnetic resonance (NMR) studies. A few investigations also have shown that after fluorination, a high-voltage (HV) LiNi_{0.5}Mn_{1.5}O₄ spinel layer can form on an LMR surface. However, it is unclear what role F plays or even where it is located in these structures.

Since the layered LMR and the HV-spinel structures share the same cubic closed oxygen sublattice that enables their integration at the atomic level, a series of “layered-layered-spinel” oxide samples with the high-capacity 0.5Li₂MnO₃·0.5LiMn_{0.5}Ni_{0.5}O₂ (“layered-layered”) and HV LiNi_{0.5}Mn_{1.5}O₄ (spinel) components were also designed and prepared by one research group without the involvement of fluorination. In their studies, the excess Li⁺ cations accompanying the irreversible O₂ release were reaccommodated in the HV spinel to form the over-lithiated Li₂Ni_{0.5}Mn_{1.5}O₄ phase upon discharging to below 3 V, thereby increasing the ICE and discharge capacity. They further proposed that integrating HV spinel structure into layered LMR may alleviate Jahn-Teller distortion and Mn dissolution, owing to the improved tolerance of HV spinel component with an average Mn oxidation state of 3.33+ instead of 3+ at the fully lithiated state. Further, particle surface layer construction was also used to tune the chemical environment for redox-active oxygen and reduce the extent of surface lattice oxygen escape. The authors attributed the decreased irreversible oxygen loss to the formation of Ni-enriched spinel layers on the surface.

### SUMMARY

One innovative aspect of the subject matter described in this disclosure can be implemented in a method including mixing metal precursors to form a first mixture. The metal precursors include a lithium precursor and a manganese precursor. A halide mixture is mixed with the first mixture to form a second mixture. The halide mixture includes a fluorine precursor and a chlorine reaction medium. The second mixture is heat treated to generate a fluorinated Li- and Mn-rich oxide.

Another innovative aspect of the subject matter described in this disclosure can be implemented in a composition including a fluorinated Li—Mn-rich oxide with 0.5 molar % F or higher. In some aspects, the composition substantially is Li_{+z}NiₓMn_{1-x-z}O_{2-y}F_{y}, with 0.05≤x≤0.4, 0.01≤y≤0.1, and 0.05≤z≤0.3. In some aspects, the composition substantially is Li_{1.2}Ni_{0.2}Mn⁴⁺_{0.59}Mn³⁺_{0.01}O_{1.99}F_{0.01}, Li_{1.2}Ni_{0.2}Mn⁴⁺_{0.575}Mn³⁺_{0.025}O_{1.975}F_{0.025}, or Li_{1.2}Ni_{0.2}Mn⁴⁺_{0.55}Mn³⁺_{0.05}O_{1.95}F_{0.05}. In some aspects, the composition is in the form of single crystal particles having dimensions of about 50 nanometers to 5 microns.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows laboratory and FIG. 1B shows synchrotron powder XRD patterns of as-synthesized crystal samples. XRD patterns of HV spinel LiNi_{0.5}Mn_{1.5}O₄ and LiF are added in FIG. 1B for reference. SEM images of (FIG. 1C) LNMO, (FIG. 1D) LNMO-F1, (FIG. 1E) LNMO-F2.5, and (FIG. 1F) LNMO-F5 are shown. The atomic structure of layered LNMO is shown in FIG. 1G and a schematic showing the indexed crystal facets is shown in FIG. 1H.

STEM-HAADF (FIGS. 2A and 2C) and STEM-ABF (FIGS. 2B and 2D) images of LNMO-F5 along (FIGS. 2A and 2B) [010] and (FIGS. 2C and 2D) [101] zone axes are shown. FIGS. 2E-2L show STEM-EDX mapping and the corresponding estimated atomic percentage at (102) (FIGS. 2E-2G and 2K) and (003) (FIGS. 2H-2J and 2L) crystal planes of LNMO-F5. The probe depth is 40 nm. FIGS. 2M-2O show STEM-HAADF and the corresponding FFT images collected in the bulk region of LNMO-F5.

FIGS. 3A-3D show Mn 2p and FIGS. 3E-3I show Mn 3s XPS spectra of the single-crystal samples. Mn L-edge soft XAS profiles of the samples were collected in (FIG. 3I) TEY and (FIG. 3J) FY mode. FIG. 3K shows Mn³⁺ contents estimated from the various characterization techniques.

FIGS. 4A-4F show STEM-HAADF and Mn L₂/L₃-edge STEM-EELS spectra collected on an LNMO-F5 crystal probed: (FIGS. 4A-4C) in the (102) surface region of 1 to 31 nm at a step size of 6 nm and (FIGS. 4D-4F) in the bulk region from 120 to 820 nm at a step size of 50 nm.

FIGS. 5A-5D show voltage profiles of (FIG. 5A) LNMO, (FIG. 5B) LNMO-F1, (FIG. 5C) LNMO-F2.5, and (FIG. 5D) LNMO-F5 cathodes at 0.1C in the voltage range of 2-4.8 V. FIGS. 5E-5H show the corresponding dQ/dV profiles of (FIG. 5E) LNMO, (FIG. 5F) LNMO-F1, (FIG. 5G) LNMO-F2.5, and (FIG. 5H) LNMO-F5 cathodes from the 1st cycle to 50th cycle. FIGS. 5I-5L show comparisons of (FIG. 5I) specific capacities, (FIG. 5J) average discharge voltage, (FIG. 5K) energy density, and (FIG. 5L) energy density retention of LNMO and fluorinated LNMO cathodes.

FIG. 6A-6D show normalized O K-edge XAS spectra and the corresponding differential spectral analysis of (FIGS. 6A and 6C) pristine LNMO and LNMO-F5 and (FIGS. 6B and 6D) recovered LNMO and LNMO-F5 cathodes after charging to 4.7 V. FIGS. 6C and 6D are expanded views of the pre-edge regions in FIGS. 6A and 6B, respectively.

FIG. 7 shows an example of a flow diagram illustrating a manufacturing process for a fluorinated lithium- and manganese-rich layered oxide.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

The common fluorination methods for lithium- and manganese-rich (LMR) layered oxides involve solid-state mixing of LiF and preformed LMR particles to obtain fluorinated-LMR, known as the post-synthesis fluorination technique. Due to the high thermodynamic stability of LiF and the stronger affinity of F anions toward Li than the TMs, this approach often leads to the formation of LiF secondary phase on the surface of LMR particles rather than the incorporation of F anions into the oxygen anion sublattice.

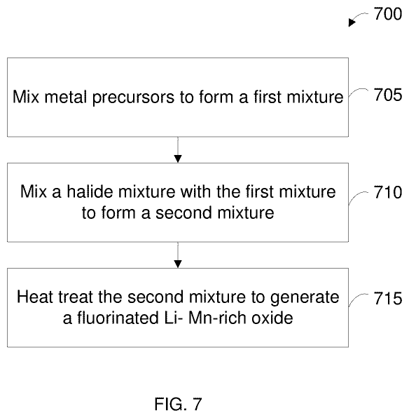

Described herein are embodiments of a new fluorination method. FIG. 7 shows an example of a flow diagram illustrating a manufacturing process for a fluorinated lithium- and manganese-rich layered oxide.

Starting at block 705 of the method 700 shown in FIG. 7, metal precursors are mixed to form a first mixture. The metal precursors include a lithium precursor and a manganese precursor. In some embodiments, mixing the metal precursors includes ball milling the metal precursors.

In some embodiments, the lithium precursor is a precursor from a group lithium carbonate (Li2CO3), LiOH, Li₂O, LiCl, lithium acetate (CH₃COOLi), LiNO₃, and Li₂SO₄. In some embodiments, the lithium precursor is not LiF. In some embodiments, the manganese precursor is a precursor from a group manganese(II) acetate (Mn(CH3COO)2·4H2O), MnO, Mn₂O₃, MnO₂, MnSO₄, and MnCl₂.

In some embodiments, the metal precursors further include a nickel precursor. In some embodiments, the nickel precursor is a precursor from a group nickel(II) acetate (Ni(CH3COO)2·4H2O), NiO, Ni₂O₃, NiSO₄, and NiCl₂.

In some embodiments, the metal precursors further include a nickel precursor and a cobalt precursor. In some embodiments, the nickel precursor is a precursor from a group nickel(II) acetate (Ni(CH3COO)2·4H2O), NiO, Ni₂O₃, NiSO₄, NiCl₂. In some embodiments, the cobalt precursor is a precursor from a group Co(CH3COO)₂·4H₂O), CoO, CoSO₄, CoCO₃, CoCl₂, and Co(NO₃)₂.

In some embodiments, the metal precursors further include a precursor of one or more metal dopants. In some embodiments, the metal dopant includes a metal from group Al, Ti, Fe, B, Zr, Ta, V, Cr, Mo, W, Nb, Ga, Mg, Ca, and K.

Returning to the method 700 shown in FIG. 7, at block 710 a halide mixture is mixed with the first mixture to form a second mixture. The halide mixture includes a fluorine precursor and a chlorine reaction medium.

In some embodiments, the fluorine precursor is a precursor from a group LiF, NaF, KF, MgF₂, CaF₂, NH₄F, and mixtures thereof. In some embodiments, the fluorine precursor has a low fluoroacidity.

In some embodiments, the fluorine precursor comprises a mixture of at least two or more of LiF, NaF, KF, MgF₂, CaF₂, and NH₄F mixed in about an eutectic point ratio or in a eutectic point ratio. A eutectic is a type of mixture that has a melting point lower than those of the constituents. The eutectic point ratio is the ratio of constituents that has the lowest melting point (i.e., the eutectic temperature) compared to other ratios. In some embodiments, the fluorine precursor comprises a mixture of at least two or more of LiF, NaF, KF, MgF₂, CaF₂, and NH₄F mixed in a ratio within about 5 molar percent of an eutectic point ratio.

In some embodiments, fluorine precursor is a mixture of KF and LiF. In some embodiments, a KF/LiF molar ratio is about 49:51.

In some embodiments, the chlorine reaction medium is a compound from a group NaCl, KCl, CsCl, LiCl, and mixtures thereof. In some embodiments, a manganese (from the metal precursors)/chlorine (from the chlorine reaction medium) molar ratio is about 1:1 to 1:16, or about 1:8.

In some embodiments, the mixing the metal precursors and the mixing the halide mixture with the first mixture is performed in a single mixing operation. In some embodiments, mixing the halide mixture and the metal precursors includes ball milling the halide mixture and the metal precursors. In some embodiments, the method 700 further includes mixing the fluorine precursor and the chlorine reaction medium to form the halide mixture. In some embodiments, the mixing the metal precursors, the fluorine precursor, and the chlorine reaction medium is performed in a single mixing operation.

Returning to the method 700 shown in FIG. 7, at block 715 the second mixture is heat treated to generate a fluorinated Li- and Mn-rich oxide. In some embodiments, the heat treatment of the second mixture includes a heat treatment at about 350° C. to 500° C. for about 5 hours to 7 hours and followed by a heat treatment at about 700° C. to 950° C. for about 8 hours to 12 hours. In some embodiments, the heat treatment of the second mixture includes a heat treatment at about 450° C. for about 6 hours followed by a heat treatment at about 900° C. for about 12 hours. In some embodiments, the heat treatment is performed in air.

In some embodiments, the method 700 further includes after the heat treatment, washing the second mixture to substantially remove any halide residues. Halide residues may include, for example, the chlorine reaction medium that was inert during the heat treatment. Washing the second mixture may include sonicating the second mixture.

In some embodiments, the fluorinated Li- and Mn-rich oxide is fluorinated with 0.5 molar % F or higher, with 2.5 molar % F or higher, with 5 molar % F or higher, or with 7.5 molar % F or higher. In some embodiments, the fluorinated Li- and Mn-rich oxide is fluorinated with 0.5 molar % F to 10 molar % F, with 2.5 molar % F to 10 molar % F, with 5 molar % F to 10 molar % F, or with 7.5 molar % F to 10 molar % F.

In some embodiments, the fluorinated Li- and Mn-rich oxide substantially is Li_{1+z}NiMn_{1-x-z}O_{2-y}F_{y}, with 0.05≤x≤0.4, 0.01≤y≤0.1, and 0.05≤z≤0.3. In some embodiments, the fluorinated Li- and Mn-rich oxide substantially is Li_{1.2}Ni_{0.2}Mn⁴⁺_{0.59}Mn³⁺_{0.01}O_{1.99}F_{0.01}, Li_{1.2}Ni_{0.2}Mn⁴⁺_{0.575}Mn³⁺_{0.025}O_{1.975}F_{0.025}, or Li_{1.2}Ni_{0.2}Mn⁴⁺_{0.55}Mn³⁺_{0.05}O_{1.95}F_{0.05}.

In some embodiments, the fluorinated Li- and Mn-rich oxide is in the form of single crystal particles having dimensions of about 50 nanometers (nm) to 5 microns, about 50 nm and larger, about 1 micron and larger, about 2 microns and larger, about 3 microns and larger, about 4 microns and larger, or about 5 microns and larger.

The following examples are intended to be examples of the embodiments disclosed herein, and are not intended to be limiting.

### Example—Synthesis and Properties of F-LNMO Single Crystals

Described below is an investigation of a new in situ fluorination method based on a molten-salt synthesis technique. A series of LNMO and F-LNMO single crystals with the general formula of Li_{1.2}Ni_{0.2}Mn_{0.6}O₂₋ₓFₓ (x=0, 0.01, 0.025, and 0.05) were prepared. Assuming full incorporation of F into the O lattice and charge compensation achieved through Mn, the target compositions of the samples were Li_{1.2}Ni_{0.2}Mn⁴⁺_{0.6}O₂, Li_{1.2}Ni_{0.2}Mn⁴⁺_{0.59}Mn³⁺_{0.01}O_{1.99}F_{0.01} (LNMO-F1), Li_{1.2}Ni_{0.2}Mn⁴⁺_{0.575}Mn³⁺_{0.025}O_{1.975}F_{0.025} (LNMO-F2.5), and Li_{1.2}Ni_{0.2}Mn⁴⁺_{0.55}Mn³⁺_{0.05}O_{1.95}F_{0.05} (LNMO-F5). The corresponding Mn³⁺ contents are 0, 1.6%, 4.2%, and 8.3%, respectively.

To synthesize the samples, various fluoride salts were selected and mixed together with the stoichiometric amount of Li/Mn/Ni salt precursors in a KCl flux (mp=770° C.). Initially, LiF was used as the fluorine source. It was found that increasing the F concentration in Li_{1.2}Ni_{0.2}Mn_{0.6}O₂₋ₓFₓ from x=0.01 to 0.1 (LNMO-F10), the LiF impurity content increases continuously. This indicates that F anions were not well-incorporated into the layered crystal structure.

As the chemical nature of F salts is known to play a critical role in fluorination, the effect of fluoroacidity on the phase purity of the synthesized compounds was then investigated. Much like the pH values used for the proton acidity, fluoroacidity measures the F affinity, with the salts in the basic form being F⁻ givers and those in the acidic form being F⁻ acceptors. Fluoroacidity is often determined by measuring the concentration of electroactive gas species (SiF₄), formed between the Si additive and the free F⁻ content in the salt medium using the electrochemical techniques of cyclic and square wave voltammetry.

The F-containing salts and salt combinations investigated in this study included LiF—KF, NaF—MgF₂, NaF—CaF₂, LiF—NaF, LiF, and LiF—CaF₂. The fluoroacidity follows the following order: LiF—KF (51:49)<NaF—MgF₂ (78:22)<NaF—CaF₂ (69:31)<LiF—NaF (60:40)<LiF<LiF—CaF₂ (80:20). All ratios in the mixtures are mole ratios. The effect of fluoroacidity on phase purity of the as-synthesized sample is significant, which is demonstrated on the XRD patterns collected on LNMO-F2.5 made with various salts. The results show that sample phase purity and the fluoroacidity of the F-salt used follow the opposite directions, with the least acidic LiF—KF producing the LNMO-F2.5 phase with the highest phase purity (absence of detectable LiF impurity in XRD). Decreasing the fluoroacidity therefore was found to improve the efficacy of fluorination.

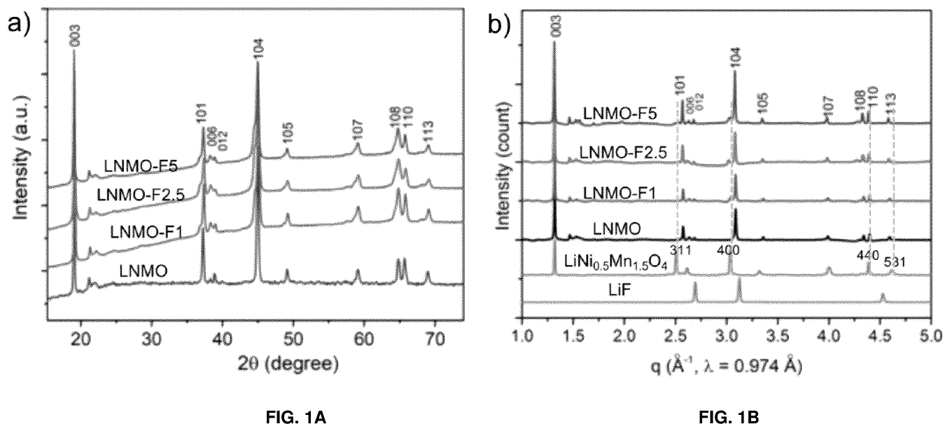

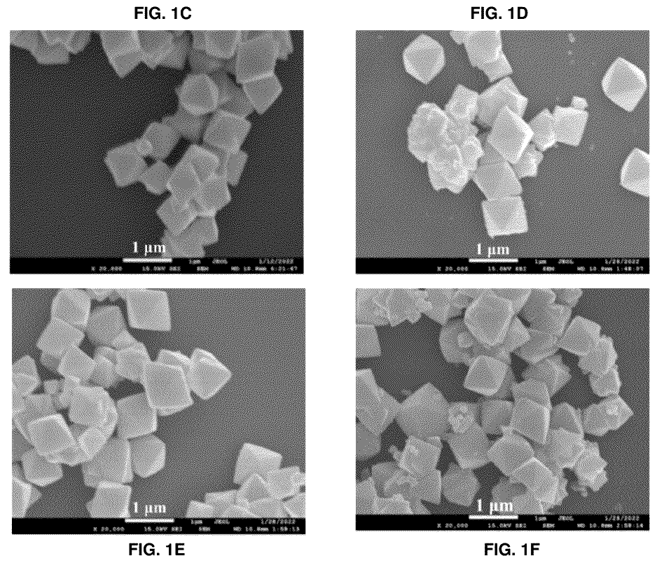

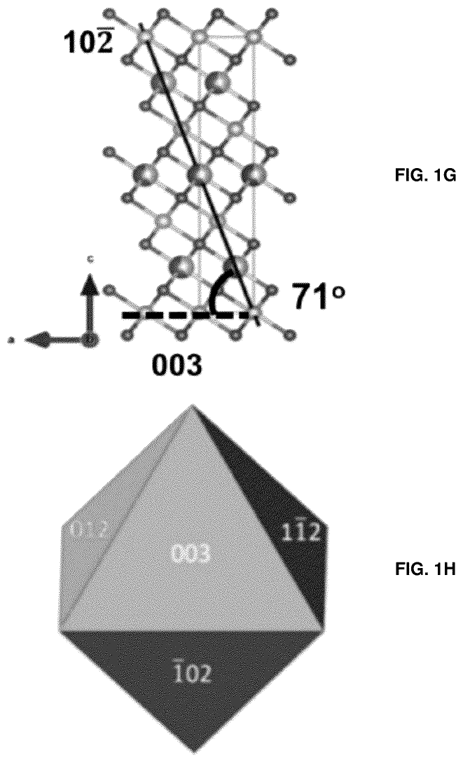

Based on these results, LNMO-F1, LNMO-F2.5, and LNMO-F5 samples were synthesized using the in situ fluorination method with LiF—KF as the F source. FIG. 1A shows the laboratory XRD patterns collected on the LNMO and F-LNMO series. Except for the additional peaks between 21° to 23°, the main patterns can be indexed to the layered hexagonal α-NaFeO₂ structure (space group R3m), which is consistent with previous reports. The clear splitting of the (006)/(012) and (108)/(110) doublets indicates well-ordered layered structure in the hexagonal lattice. Compared to those in LNMO, the (101) and (104) diffraction peaks appear broader in all F-LNMO samples, suggesting possible presence of secondary phase(s). To this end, synchrotron XRD analysis was used to further investigate the phase purity.

FIG. 1B shows the data collected on the series of samples along with the two reference samples, LiNi_{0.5}Mn_{1.5}O₄ spinel phase (Fd3̅m) and LiF. The phase purity of LNMO was confirmed. The additional diffraction peaks near the (101) and (104) main peaks in F-LNMO can be indexed to the (311) and (400) peaks of the spinel phase. The intensity of these peaks increases with the F level, with the highest intensity observed on the LNMO-F5 sample. LiF peaks were not detected in all of the samples. Although this does not exclude the possible presence of a very small amount of LiF or amorphous LiF in the sample, the results suggest that the use of more fluoro-basic F precursors can be an effective approach to LMR fluorination. The chemical compositions of the samples were further confirmed by inductively coupled plasma optical emission spectroscopy (ICP-OES) measurements. Within the error bar range, the measured F content confirms the presence of F and the increasing F content in the LNMO-F1, LNMO-F2.5, and LNMO-F5 series.

FIGS. 1C-1F show the scanning electron microscopy (SEM) images of as-synthesized LNMO and F-LNMO samples. All particles show the same single-crystal morphology, with a uniform octahedron shape and an average particle size of ˜1 μm. Fluorination has a negligible effect on both the particle size and morphology. Crystalline orientations of the surface facets were determined by using spherical aberration-corrected STEM imaging combined with focused ion beam (FIB) lithography. When examined along the [010] direction of the layered structure, the terminating planes on the particles are the (003) and (102) planes. The measured angle between them is ˜73°, which is close to the theoretical value of 71° (FIGS. 1G and 1H). Based on the octahedron morphology and the symmetry element 3̅ being perpendicular to the (003) plane, the dominating surface facets in all samples were determined to be (102)-family planes (˜88% or 7 out of 8 facets), with the (003) plane accounting for the rest of the surface (˜12%, or 1 out of 8 facets).

Further analysis of high angle annular dark field (HAADF) and annular bright field (ABF) STEM images collected along the [101] zone axis of LNMO-F5 crystals shows the presence of a spinel-like surface reconstruction layer (SRL) with a thickness of ˜2.7 nm on the (102) facet (FIGS. 2A and 2B, respectively). The spinel and the layered structures appear crystallographically coherent without the presence of phase boundaries. On the other hand, a rocksalt-type layer with a thickness of ˜1.2 nm was observed on the (003) surface facet, as shown in the HAADF and ABF STEM images in FIGS. 2C and 2D, respectively. As the (003) facet constitutes only a small fraction of the octahedron surface, the single crystals are predominately enclosed by a spinel surface layer. Similar results were also observed on the LNMO sample, indicating that surface reconstructions are independent of fluorination. The results are also consistent with previous reports on LMRs where a thin surface reconstruction layer was observed on the layer-structured samples made by various methods.

FIGS. 2E-2L compare the brightness intensity of the STEM-HAADF images collected on the (102) and (003) facets as well as the corresponding elemental distributions from the STEM-EDX analysis. While the (003) surface shows similar intensity as that in the bulk lattice, the (102) facet shows significantly higher intensity. As the brightness intensity in the STEM-HAADF imaging is roughly proportional to Z² (Z is the atomic number), the results suggest the enrichment of heavier elements on the (102) surface. Further EDX mapping analysis showed uniform distributions of both Mn and Ni in the bulk, whereas Ni is strongly enriched on the top ˜2-3 nm of the (102) facet (FIG. 2K). On the other hand, only a slight Ni segregation was observed on the (003) facet (FIG. 2L). The results suggest that the surface spinel layer is enriched with Ni (Mn/Ni ratio is <3). Similar results were also obtained on the unfluorinated LNMO sample, indicating that Ni segregation is facet-dependent but independent of the fluorination process.

Aside from the SRL presence on the surface, the spinel-like phase was also found in the bulk of LNMO-F5 crystals, as shown by the STEM imaging and the corresponding fast Fourier transform (FFT) analysis (FIGS. 2M-2O). In the STEM image, the spinel and layered structures once again appeared crystallographically coherent without the presence of phase boundaries, suggesting the coherent integration of spinel domains in the native layered framework. The corresponding FFT analysis further confirmed the nature of both phases, with the layered indexed as the hexagonal R3m structure and the spinel as the cubic P4₃32 structure. Through EDX analysis, the presence of Ni was detected in both layered and spinel phases. The extent of spinel presence as well as the ratio between Mn and Ni varied depending on the location of the F-LNMO particle. The general formula of the spinel phase is consistent with the HV spinel phase, LiNiₓMn₂₋ₓO₄, with x>0.5 (Ni-rich) on the surface.

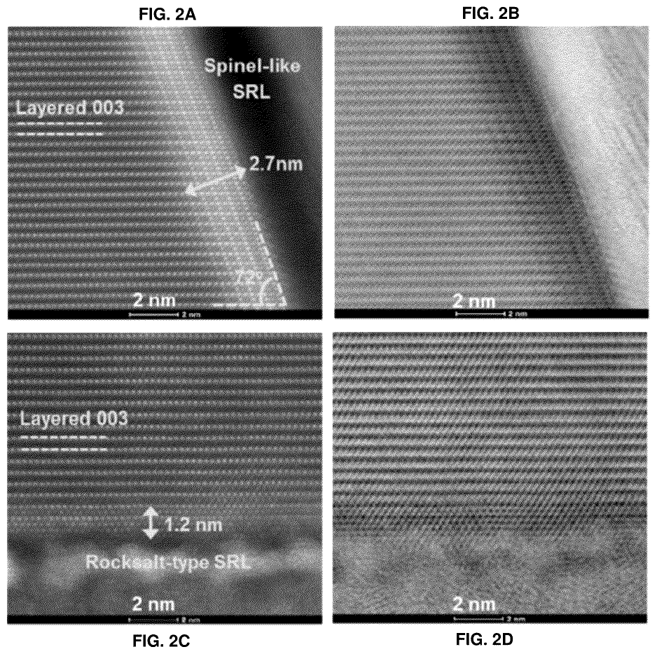

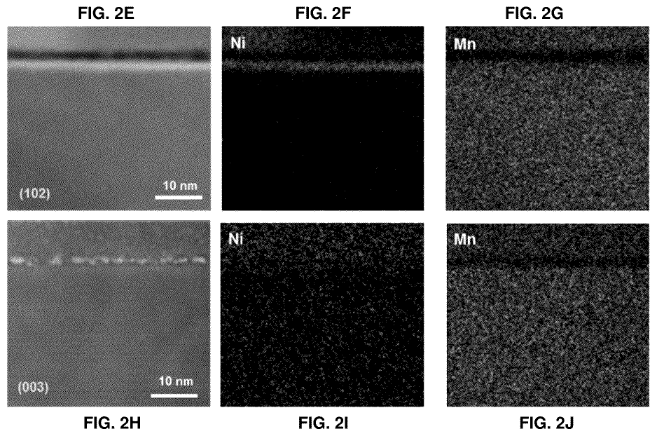

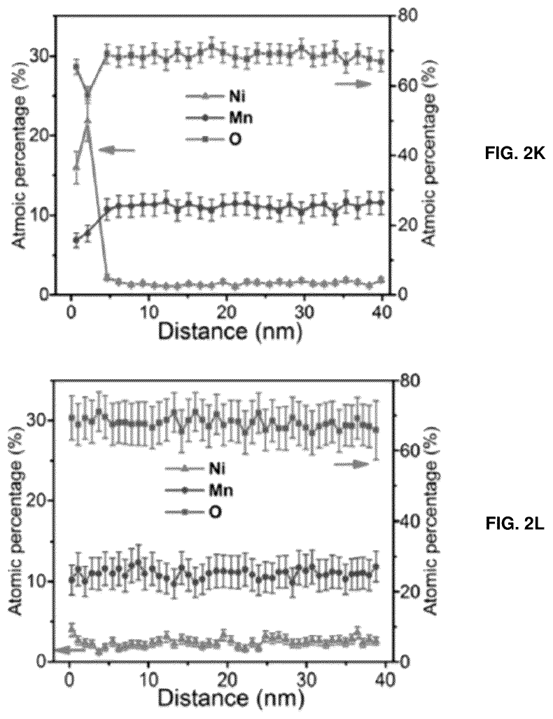

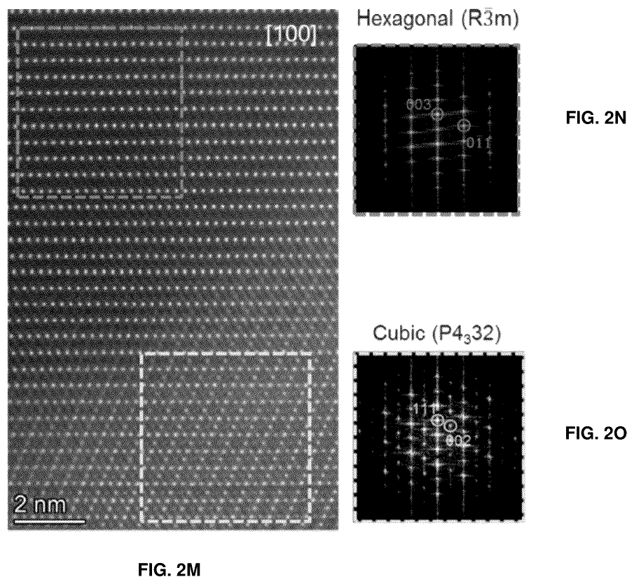

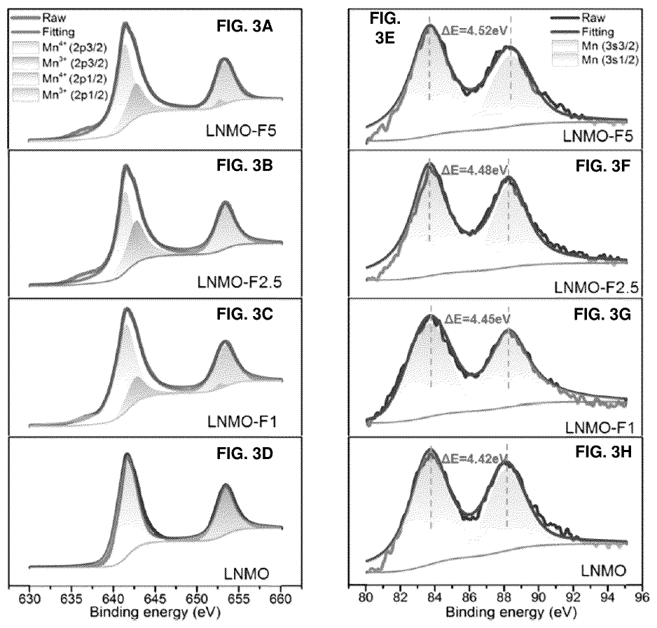

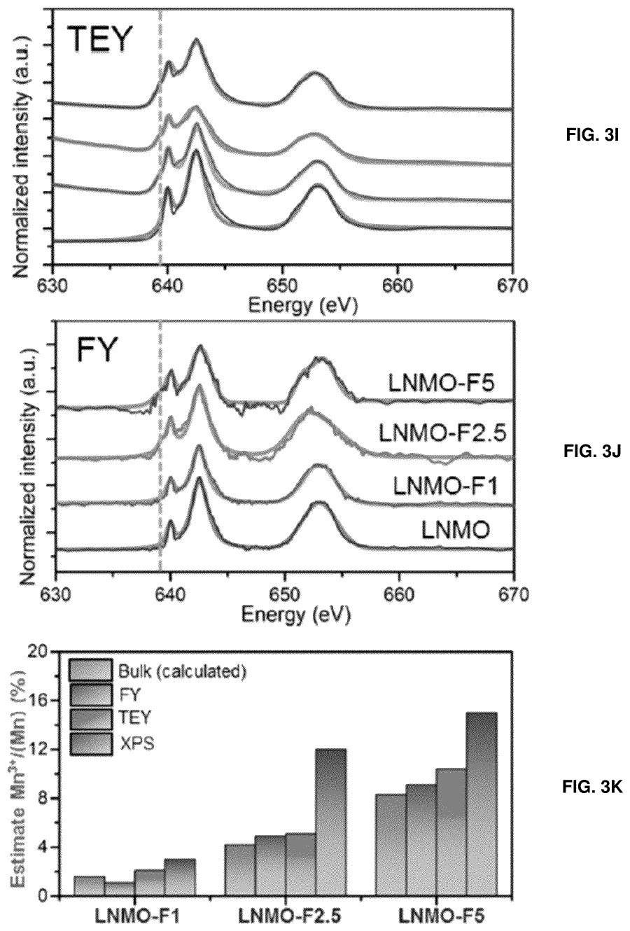

XPS, soft XAS spectroscopy, and EELS were further employed to analyze the elemental and chemical distributions in the single-crystal samples. The study aimed to probe these distributions covering the entire range of surface to bulk, with the XPS probing roughly 2 nm on the top surface, sXAS in the total electron yield (TEY) mode and fluorescence yield (FY) mode probing ˜5 nm surface and 50 nm subsurface regions, respectively, and the EELS technique combined with FIB lithography probing the bulk region. FIG. 3A-3H show the fitted Mn 2p and Mn 3s XPS spectra, respectively. For LNMO, surface Mn cations are at 4+. The presence of lower-valence Mn³⁺ cation was detected on all F-LNMO crystals, with its content increasing with the increasing fluorination level. The Ni oxidation state, on the other hand, remained unchanged for all of the LNMO and F-LNMO samples. On the F is XPS spectra, a broad peak centered around 684 eV was visible on LNMO-F2.5 and LNMO-F5, suggesting the presence of F on the sample. This value is much lower compared to the binding energy of LiF (˜685.4 eV), further confirming the absence of LiF impurity in our SC samples. Mn L-edge soft XAS spectra in both the TEY and FY detection modes are shown in FIGS. 3I and 3J, respectively. Compared to that of the LNMO sample, the L₃ absorption edges of the F-LNMO samples show an additional shoulder peak at ˜639.5 eV (dashed lines) in both TEY and FY. This is consistent with the presence of Mn³⁺ along with Mn⁴⁺ in the fluorinated samples, in comparison to the reference spectra collected on various manganese oxide standards. Thus, the formation of Mn³⁺ cations from the very top surface to the subsurface region in the F-LNMO is confirmed by combining XPS and sXAS analyses. The Mn³⁺ distribution was further evaluated by estimating its content from principle component analysis (PCA) of the collected spectra (FIG. 3K). Again, the overall Mn³⁺ content increases with fluorination level, with the highest content detected on LNMO-F5. This is consistent with the trend in calculated bulk Mn³⁺ based on charge compensation upon replacing O²⁻ with F⁻ in the lattice. Further, in a given F-LNMO sample, there is clearly a concentration gradient of Mn³⁺ as its content decreases from the top surface to the subsurface region of ˜50 nm.

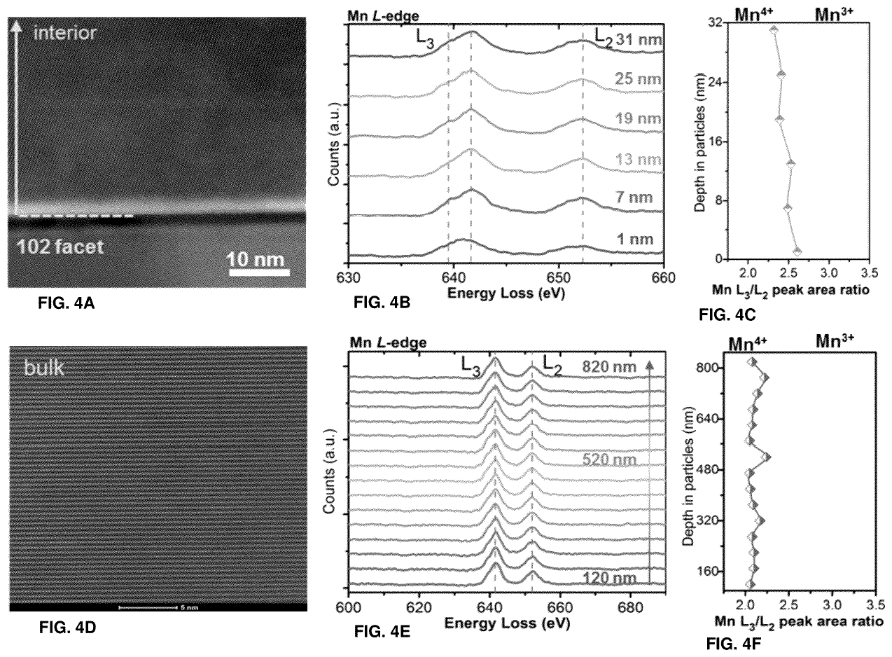

The surface to bulk distribution of the Mn oxidation state in the LNMO-F5 crystals was further examined by the STEM-EELS integrated spectroscopy. FIGS. 4A-4F show Mn L₃/L₂-edge collected in the (102) surface region of 1-31 nm and the bulk region of 120-820 nm. The peak area ratio between the L₃-edge and L₂-edge on the Mn spectra is typically used to determine the valence of Mn cations. It is clear that the Mn-L₃/L₂ peak area ratios near the (102) surface region (FIGS. 4A-4C) are broadly higher than that in the bulk region (FIGS. 4D-4F), consistent with an overall higher Mn³⁺ cation content near the surface. The gradient distribution in the Mn³⁺ content was also confirmed, with the highest content detected near the top surface and lowest content in the bulk region. The results further reveal the particle-level gradient distribution of Mn³⁺ concentration from the surface to bulk of the F-LNMO crystals. An attempt to spatially resolve F distribution, however, was unsuccessful. In the STEM-EELS analysis, the detected F signals fall into the noise level due to its low concentration. In the STEM-EDX analysis, on the other hand, the F—K edge signal overlaps with the Mn-L edge signal in the F-LNMO, resulting in difficulties in deconvoluting the signals.

In all, detailed characterization revealed that in LNMO single crystals, the surface is enclosed with a thin layer of spinel LiNiₓMn₂₋ₓO₄ (x>0.5), whereas the bulk remains the layered structure. Upon fluorination, there is a concentration gradient of Mn³⁺ whose content decreases from the top surface to the subsurface region of the F-LNMO particle. This can be attributed to the formation of a Ni-enriched Li_{z}NiₓMn₂₋ₓO_{4-y}F_{y} (x>0.5) phase where Mn³⁺ is generated upon charge compensation. As charge compensation can also be achieved by changes in the Li stoichiometry in this case, it is possible that the Li content (z) deviates from 1. Particularly, locally lithium-rich cation disordered environments are known to be enablers for F incorporation into cathode materials such as cation-disordered rocksalts. Their presence may play a key role in LNMO fluorination, as well. Lower Mn³⁺ content was found in the subsurface, which may result from the formation of spinel LiNiₓMn₂₋ₓO₄ (x<0.5) domains or some F incorporation into the spinel and/or the layered structures. On the other hand, bulk Mn remains at 4+, suggesting a “spinel-layered” structure where domains of the LiNi_{0.5}Mn_{1.5}O₄ spinel phase are integrated into the native layered framework.

### Example—Electrochemical Performance of F-LNMO Single-Crystal Cathodes

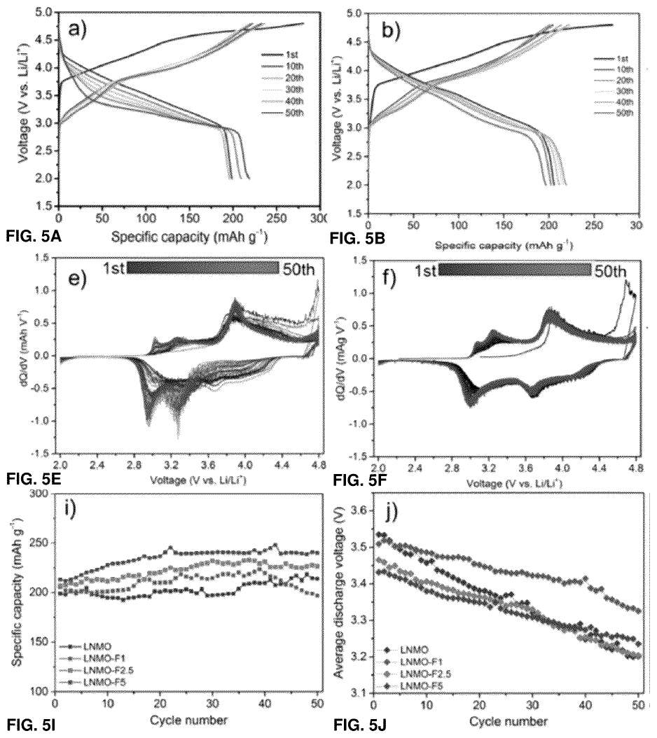

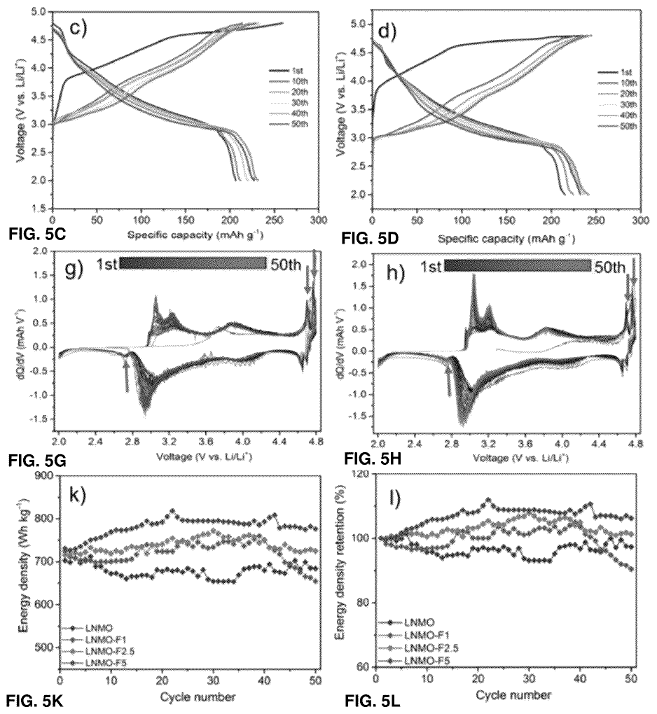

Electrochemical performance of the as-synthesized LNMO and F-LNMO cathodes was evaluated in standard half-cell CR 2032-coin cell configuration with a Gen 2 electrolyte (1 M LiPF₆ in EC/EMC 3:7). FIGS. 5A-5D shows the charge/discharge voltage profiles of the cells when cycled at 0.1C in the voltage window of 2-4.8 V. All samples showed the typical first cycle charge curve with a sloping profile below 4.5 V (vs. Li⁺/Li) and a long plateau above 4.5 V. On discharge, the LNMO and LNMO-F1 samples showed the typical S-shaped profile (FIGS. 5A and 5B) while that of LNMO-F2.5 and LNMO-F5 showed additional voltage plateaus centered at ˜2.7, 4.7, and 4.75 V (FIGS. 5C and 5D). The differences are clearly shown in the corresponding dQ and dV profiles (FIGS. 5E and 5H). Upon further cycling, the LNMO cathode experienced significant changes in the voltage profile, accompanied by a gradual decrease in average discharge voltage and the formation of a new reduction peak at ˜2.9 V. This is consistent with the cycling-induced layered-to-spinel (LiMn₂O₄-type not the HV-spinel) transition previously reported on LMR cathodes. On the other hand, no significant changes were observed on that of F-LNMO cathodes, suggesting that the detrimental phase transition process is suppressed by fluorination.

For LNMO-F2.5 and LNMO-F5, the additional redox processes occurring at ˜2.7, 4.7, and 4.75 V in the first cycle are active in the following cycles, and they continue to contribute to charge storage capacity. These redox couples are known as the signature of high-voltage spinel cathodes (LiNiₓMn₂₋ₓO₄). During charge and discharge, the two plateaus separated by approximately 50 mV at 4.7 V are consistent with the two-step extraction/insertion process associated with the 8a tetrahedral sites of the cubic spinel structure utilizing the Ni²⁺/Ni⁴⁺ redox couple. The reaction plateau at ˜2.7 V is associated with the insertion of Li⁺ into the 16c octahedral sites of the spinel phase, where lithium ions are displaced from tetrahedral to octahedral sites with the concomitant reduction of Mn from 4+ to 3+. Discharged F-LNMO cathodes, therefore, can be expected to have increased Mn³⁺ content compared to the pristine electrode. The results show that repeated involvement of the HV-spinel component in the as-synthesized F-LNMO provides a stabilizing effect on LMR cycling.

FIG. 5I compares the discharge capacities of the LNMO and the F-LNMO cathodes. The initial discharge capacities were ˜201, 206, 210, and 220 mAh g⁻¹ for LNMO, LNMO-F1, LNMO-F2.5, and LNMO-F5 cathodes, respectively. The increased capacity in F-LNMO is attributed to the involvement of the LiNiₓMn₂₋ₓO₄ HV spinel phase. The presence of Mn³⁺ likely leads to an increase in the electronic conductivity, and the increased amount of the spinel phase enables more Li⁺ accommodation through overlithiation of the spinel phase upon discharge (the theoretical capacity of the overlithiated Li₂Ni_{0.5}Mn_{1.5}O₄ is 282 mAh g⁻¹). Further, the spinel phase has faster 3D Li-ions diffusion pathways than the 2D diffusion pathways in the layered structure. When cycled at a given current density, this leads to improved active material utilization and higher cathode capacity. After 50 cycles, the specific discharge capacities changed to ˜210, 198, 226, and 240 mAh g⁻¹, with a capacity retention of ˜106%, 97%, 109%, and 114%, respectively. The increase in capacity is likely due to enhanced ionic and electronic conduction as well as electrolyte wetting upon cycling of the composite cathode, a “break-in” process that has been reported previously. In addition, the initial Coulombic efficiency was also improved in F-LNMO, reaching 78%, 79%, and 84% for LNMO-F1, LNMO-F2.5, and LNMO-F5, respectively, as compared to 71% for LNMO.

FIG. 5J compares the average discharge voltage. Although the data has not been iR-corrected, it is believed the comparison within the series is meaningful, as the only variable among different composite cathodes is the fluorination of the active material. All cathodes showed a gradual decrease in average discharge voltage during cycling; however, the extent of decay is significantly reduced in all F-LNMO cathodes. While LNMO-F5 showed the best cycling stability, the LNMO-F1 cathode appears to be most stable against voltage decay, suggesting that voltage decay is only one of the contributors to the overall cycling stability. An improved energy density and energy density retention in the F-LNMO cathodes was also observed. After 50 cycles, the values were 725 and 775 Wh kg⁻¹ for LNMO-F2.5 and LNMO-F5, respectively, as compared to 695 Wh kg⁻¹ for LNMO (FIG. 5K). The corresponding energy density retention was 96%, 91%, 102%, and 106% for LNMO, LNMO-F1, LNMO-F2.5, and LNMO-F5, respectively (FIG. 5L).

It is noted that the capacity of the LNMO cathodes is relatively low compared to some of those reported in the literature. This is due to the large micrometer size of the single-crystal particles as opposed to the polycrystalline samples composed of primary particles in tens of nm size. The increased diffusion length in the active particles leads to a lower material utilization and consequently a lower capacity. Nonetheless, the results clearly demonstrate that excellent performance can be achieved even on large micrometer-sized LNMO particles. Fluorination has a positive effect on the electrochemical performance of LNMO single-crystal cathodes, with improvement achieved in nearly all performance metrics, including discharge capacity and capacity retention, Coulombic efficiency, average discharge voltage and voltage retention, energy density, and energy density retention. It is noted that a large fraction of charge storage capacity in LNMO-F2.5 and LNMO-F5 cathodes involves the Mn³⁺/Mn⁴⁺ redox and the Ni²⁺/Ni⁴⁺ redox above 4.5 V, increasing the energy output of the cathodes. This is in contrast to what is observed in traditional LMR cathodes where the anionic redox occurring above 4.5 V leads to an O loss and the involvement of Mn³⁺/Mn⁴⁺ redox is associated with the undesirable layered-to-spinel transformation, both of which cause capacity and voltage decay.

Further, it is noted that the effect of fluorination level on LMR performance is likely exacerbated on these micrometer-sized single crystals. Previous studies have shown that in nanosized LMR, significant performance improvement can be achieved through surface focused fluorine treatments such as surface fluorine coating or electrolyte fluorination. It is possible that high fluorination levels do not have the same impact on small LMR particles with much larger surface areas. However, large micro-sized particles have many advantages over nanoparticles, and approaches to enable their use as cathode materials are especially attractive for developing next-generation LIB systems.

### Example—Understanding the Fluorination Effect on LNMO Single-Crystal Cathodes

To understand the fluorination effect on LMR, a range of post-mortem analyses on the cycled electrodes were performed. Discharged LNMO and LNMO-F5 cathodes recovered after various cycle numbers were analyzed by synchrotron XRD. For the pristine electrodes, only the layered phase was detected on the LNMO cathode, while both spinel and layered phases were found on the LNMO-F5 cathode. The recovered cathodes showed that the spinel phase remains nearly unchanged in its peak position and intensity during the initial cycling of the LNMO-F5 cathode. On the other hand, the discharged LNMO cathodes showed a newly formed spinel phase which gradually increased its content with cycling. Compared to the preformed HV spinel in LNMO-F5, the spinel peaks that appeared during LNMO cycling are much broader and they have lower intensity, corresponding to in situ generated small spinel domains.

The particle-level chemical distribution of Ni and Mn before cycling and after 10 cycles was further compared using hard X-ray full-field transition microscopy imaging combined with the X-ray absorption near-edge structure (FF-TXM-XANES) technique. The brightness and the energy tunability of synchrotron-based hard X-ray enable nanoscale spatial resolution at ˜30 nm along with high chemical and elemental sensitivities in a large field-of-view (FOV, 30 μm×30 μm). T×M images and the corresponding 2D nanoscale Mn and Ni K-edge imaging of the pristine LNMO and LNMO-F5 cathodes were generated. The 2D chemical maps were generated by linear combination fitting of the standard XANES spectra. In the raw tomography images, LNMO and LNMO-F5 electrodes contained large areas of conductive carbon additive or binder, which were difficult to separate from the active material. Nonetheless, lateral chemical heterogeneity in Mn oxidation states was clearly visible in the 2D Mn K-edge energy distribution map of LNMO-F5, with the presence of Mn³⁺ on the surface and Mn⁴⁺ only in the bulk. On the other hand, the Mn oxidation state is at 4+ throughout the LNMO particles, which is consistent with the results of Mn L-edge spectra in s-XAS and EELS data. After cycling, a small percentage of low-valence Mn³⁺ cations are present on LNMO, corresponding to the layered-to-spinel transformation during cycling. For LNMO-F5, there is a large increase in Mn³⁺ content after 10 cycles, confirming the overlithiation of the spinel phase upon discharge which is accompanied by the formation of Mn³⁺ in the structure. In addition, the Ni oxidation state for LNMO and LNMO-F5 particles remains at 2+ after 10 cycles, demonstrating that the Ni redox process is highly reversible in both cases.

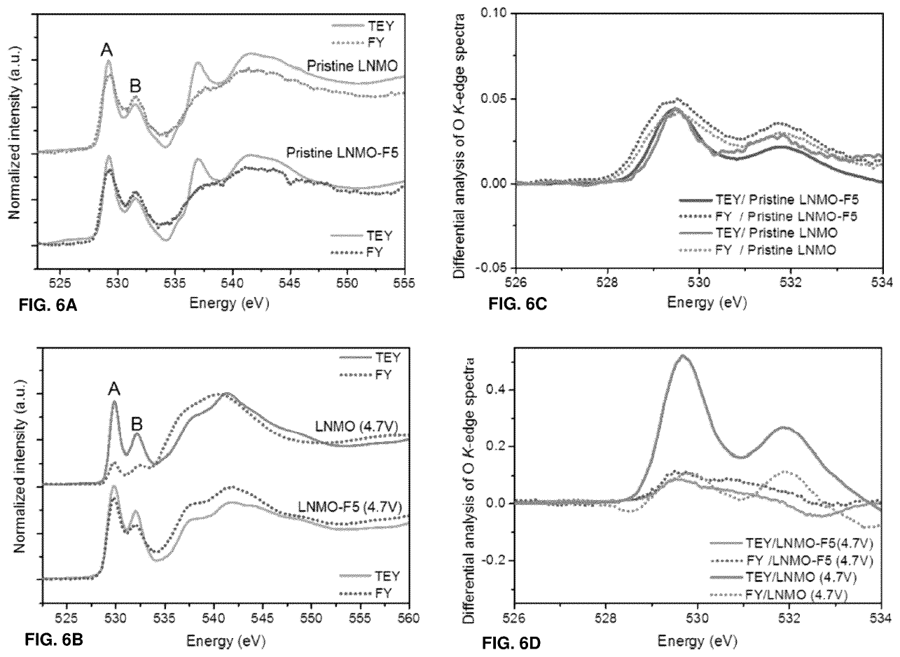

O K-edge soft X-ray spectroscopy was also used to compare oxygen activities in the LNMO and LNMO-F2.5 electrodes. The TEY and FY spectra of both pristine electrodes are similar (FIGS. 6A and 6C). The spectra display two regions: (1) a pre-edge between 525-535 eV corresponding to the O₁ₛ to TM_{3d}-O₂ₚ transition, where the pre-edge peak A at 529.6 eV comes from the excitation of O is electrons to the hybridized O 2p-t2g orbitals and the pre-edge peak B at 531.9 eV is attributed to the hybridized O 2p-eg orbitals, and (2) a broad peak above 535 eV arising from the O₁ₛ to TM₄ₛ₄ₚ-O₂ₚ transitions. The pre-edge region is of greater importance as it relates to the hybridization between TM and O. The changes in the pre-edge intensity are therefore associated with the changes in TM valence and oxygen activities. FIGS. 6B and 6D show the TEY and FY spectra obtained on charged cathodes after the initial cycles, respectively. The TM_{3d}-O₂ₚ pre-edge intensity of LNMO in the TEY mode is higher than that in FY mode (FIG. 6B), indicating enhanced hybridization of TM_{3d}-O₂ₚ on the surface than that in the subsurface. Considering minimum changes on Mn and Ni oxidation states (FIGS. 3A-3K), the differences suggest enhanced O activities on the LNMO surface compared to the subsurface region. On the other hand, there are no significant changes in the pre-edge region of the TEY and FY spectra collected on the charged LNMO-F5 cathode, suggesting a similar level of TM_{3d}-O₂ₚ hybridization. This is further shown by comparing the TEY and FY O K-edge XAS spectra peak features in both LNMO and LNMO-F5 (FIG. 6D).

The oxygen redox activities in LMR cathodes are known to involve both the reversible redox process and irreversible oxygen release. While the reversible oxygen redox typically occurs in the bulk lattice, oxygen release only occurs on the surface. TM_{3d}-O₂ₚ pre-edge intensity in the FY spectra of LNMO and LNMO-F5 cathodes is at a similar level, suggesting similar O activities in the subsurface region. Compared to that in LNMO, the lower TEY TM_{3d}-O₂ₚ pre-edge intensity in LNMO-F5 is likely associated with reduced O₂ release from the surface.

This was confirmed by operando differential electrochemical mass spectrometry (DEMS) analysis. A small amount of O₂ gas (3.9 mol g⁻¹) was detected during the first cycle of LNMO, whereas negligible O₂ evolution was found on the LNMO-F5 cathode. Notably, a large amount of CO₂ (118.4 mol g⁻¹) evolution was detected during the first cycle as well as the following cycle of the former, whereas CO₂ evolution was not detected in the latter. As the main source of CO₂ generation is from the side reactions between the cathode and the carbonate-based electrolyte, the results indicate that fluorination not only minimizes the irreversible oxygen loss from the surface but also reduces the detrimental side reactions at high voltages. This is consistent with the results from a recent study where gradient-fluorination was found to induce a uniform deposition of a thin but robust LiF-enriched cathode-electrolyte interphase (CEI) layer, which provides protection for the cathode surface.

### CONCLUSION

In summary, by variation of the fluoroacidity of the fluorine source, phase-pure fluorinated-LNMO single crystals were successfully synthesized using a molten-salt synthesis technique. STEM-EELS analysis revealed that the dominating facets of the single-crystal octahedral particles are (012)-family facets. Fluorination improved the specific capacity and capacity retention, Coulombic efficiency, average voltage, and voltage retention as well as energy density and energy retention of the LMR cathodes. The detected surface-to-bulk Mn³⁺ concentration variation was used to determine the reasons behind the improvement. Mn³⁺ cations were generated as a result of charge balance from the fluorine incorporation into the spinel lattice and the formation of Ni-rich Li_{z}NiₓMn₂₋ₓO_{4-y}F_{y} (x>0.5) on the surface. The bulk was composed of a “spinel-layered” coherent structure, where domains of a LiNi_{0.5}Mn_{1.5}O₄ high-voltage spinel phase are integrated into the native layered framework. It is believed that the performance enhancement in F-LNMO cathodes is related to the synergic effect of fluorine incorporation and the presence of the high-voltage LiNiₓMn_{y}O₄ spinel phase in the layered structure, both of which improve the structural stability of the LMR cathode.

Further details regarding the embodiments described herein can be found in F. Wang et al., “Fluorination Effect on Lithium- and Manganese-Rich Layered Oxide Cathodes,” ACS Energy Lett. 2024, 9, 1249-1260, which is hereby incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
mixing metal precursors to form a first mixture, the metal precursors including a lithium precursor and a manganese precursor;
mixing a halide mixture with the first mixture to form a second mixture, the halide mixture including a fluorine precursor and a chlorine reaction medium; and
heat treating the second mixture to generate a fluorinated Li- and Mn-rich oxide.

2. The method of claim 1, further comprising:
after the heat treating, washing the second mixture to substantially remove any halide residues.

3. The method of claim 1, wherein the lithium precursor is a precursor from a group lithium carbonate (Li2CO3), LiOH, Li₂O, LiCl, lithium acetate (CH₃COOLi), LiNO₃, and Li₂SO₄.

4. The method of claim 1, wherein the lithium precursor is not LiF.

5. The method of claim 1, wherein the manganese precursor is a precursor from a group manganese(II) acetate (Mn(CH3COO)2·4H2O), MnO, Mn₂O₃, MnO₂, MnSO₄, and MnCl₂.

6. The method of claim 1, wherein the metal precursors further include a nickel precursor.

7. The method of claim 1, wherein the metal precursors further include a precursor of one or more metal dopants, and wherein the metal dopant includes a metal from group Al, Ti, Fe, B, Zr, Ta, V, Cr, Mo, W, Nb, Ga, Mg, Ca, and K.

8. The method of claim 1, wherein the fluorine precursor is a precursor from a group LiF, NaF, KF, MgF₂, CaF₂, NH₄F, and mixtures thereof.

9. The method of claim 1, wherein the fluorine precursor comprises a mixture of at least two or more of LiF, NaF, KF, MgF₂, CaF₂, and NH₄F mixed in about an eutectic point ratio.

10. The method of claim 1, wherein the fluorine precursor comprises a mixture of at least two or more of LiF, NaF, KF, MgF₂, CaF₂, and NH₄F mixed in a ratio within about 5 molar percent of an eutectic point ratio.

11. The method of claim 1, wherein the fluorine precursor is a mixture of KF and LiF.

12. The method of claim 11, wherein a KF/LiF molar ratio is about 49:51.

13. The method of claim 1, wherein the chlorine reaction medium is a compound from a group NaCl, KCl, CsCl, LiCl, and mixtures thereof.

14. The method of claim 1, wherein a manganese/chlorine molar ratio is about 1:1 to 16:1.

15. The method of claim 1, wherein the heat treating the second mixture includes a heat treatment at about 350° C. to 500° C. for about 5 hours to 7 hours and followed by a heat treatment at about 700° C. to 950° C. for about 8 hours to 12 hours.

16. The method of claim 1, wherein the heat treating the second mixture includes a heat treatment at about 450° C. for about 6 hours followed by a heat treatment at about 900° C. for about 12 hours.

17. The method of claim 1, wherein the fluorinated Li—Mn-rich oxide is fluorinated with 0.5 molar % F or higher.

18. The method of claim 1, wherein the Li Mn-rich oxide substantially is Li_{+z}NiₓMn_{1-x-z}O_{2-y}F_{y}, with 0.05≤x≤0.4, 0.01≤y≤0.1, and 0.05≤z≤0.3.

19. A composition comprising a fluorinated Li—Mn-rich oxide with 0.5 molar % F or higher.

20. The composition of claim 19, wherein the composition substantially is Li_{1+z}NiₓMn_{1-x-z}O_{2-y}F_{y}, with 0.05≤x≤0.4, 0.01≤y≤0.1, and 0.05≤z≤0.3.
